(19) United States
(12) Patent Application Publication
(10) Pub. No.: US 2025/0246679 A1
(43) Pub. Date: Jul. 31, 2025

(54) Solid Electrolytes, Batteries, and Methods

(71) Applicant: The Florida State University Research Foundation, Inc., Tallahassee, FL (US)

(72) Inventors: Yan-Yan Hu, Tallahassee, FL (US); Michael J. Deck, Tallahassee, FL (US)

(21) Appl. No.: 19/078,904

(22) Filed: Mar. 13, 2025

Related U.S. Application Data
(62) Division of application No. 17/673,547, filed on Feb. 16, 2022.
(60) Provisional application No. 63/149,818, filed on Feb. 16, 2021.

(51) Int. Cl. H01M 10/0562; C01B 25/14; C01D 15/00; H01M 10/0525

(52) U.S. Cl. CPC H01M 10/0562; C01B 25/14; C01D 15/00; H01M 10/0525; C01P 2002/72; C01P 2002/86; C01P 2006/40; H01M 2300/0071

(57) ABSTRACT

Electrolytes, methods of preparing electrolytes, and batteries include electrolytes. Electrolytes may include a material of formula (I), LiₐPS₄₋ₓOₓ, wherein x is 0<x≤1. The electrolytes may be glass-ceramic electrolytes. Batteries including electrolytes may be lithium-ion batteries.

### CROSS-REFERENCE TO RELATED APPLICATIONS

This application is a divisional of U.S. patent application Ser. No. 17/673,547, filed Feb. 16, 2022, which claims priority to U.S. Patent Application No. 63/149,818, filed Feb. 16, 2021. The content of these applications is incorporated by reference herein.

### STATEMENT REGARDING FEDERALLY SPONSORED RESEARCH OR DEVELOPMENT

This invention was made with government support under grant no. DMR-1847038 awarded by the National Science Foundation. The government has certain rights in this invention.

### BACKGROUND

Lithium-ion batteries (LIBs) have become an integral part of numerous products, such as laptops, smartphones, electric vehicles, etc. However, a safety concern of commercial LIBs stems from the use of flammable organic electrolytes. To overcome this, solid electrolytes (SEs) have been studied. However, their commercialization has been hindered for one or more reasons, such as their low ionic conductivity and poor electrochemical stability against metallic Li and the open atmosphere.

With respect to stability against O₂, H₂O, and Li, oxide SEs, such as Li₇La₃Zr₂O₁₂, have been studied, but their commercialization has been impeded by high heating temperatures, large interfacial resistance, and/or low room temperature ionic conductivity, σ_{RT}, (≤1×10⁻³ S/cm). With respect to ionic conductivity, sulfide SEs show great promise.

The Li₁₀GeP₂S₁₂ (LGPS) and argyrodite structural families represent some of the ionic conductors that have been reported, with ionic conductivities of >1×10⁻² S/cm (see, e.g., Y. Kato, et al. Nat. Energy 2016, 1, 16030; M. A. Kraft, et al. J. Am. Chem. Soc. 2018, 140, 16330-16339; and N. Kamaya, et al., Nat. Mater. 2011, 10, 682). Disadvantages of these SEs include the high cost of Ge and its undesirable reduction-oxidation processes against Li during cycling.

Li₃PS₄ has attracted attention because of its stability against lithium and low cost (Y. Yang, et al. ACS Appl. Mater. Interfaces 2016, 8, 25229-25242), however, the increased stability comes with the disadvantage of a significant decrease in ionic conductivity (σ=10⁻⁷ S/cm) (see, e.g., K. Homma, et al. Solid State Ionics 2011, 182, 53-58; M. Tachez, et al. Solid State Ionics 1984, 14, 181-185). One cause of this may be the instability of its high ionic conducting β-phase, which may convert to β-Li₃PS₄ at room temperature. To stabilize β-Li₃PS₄ at room temperature and therefore increase the ionic conductivity, nanoporous β-Li₃PS₄ synthesized via thermal treatment of Li₃PS_{4.3}THF (tetrahydrofuran) has shown some success (σ_{25°} C.=1.6×10⁻⁴ S/cm) (see, e.g., Z. Liu, et al. J. Am. Chem. Soc. 2013, 135, 975-978). This may be a result of an increase in surface energy from the nanoporous structure, which may cause a distortion in the lattice and therefore lower the temperature at which the phase transition occurs. Wet-chemical synthesis methods using THE, ¹H, ^{6.7}Li, and ³¹P solid-state nuclear magnetic resonance spectroscopy (NMR) have been utilized to identify the local structure (M. Gobet, et al. Chem. Mater. 2014, 26, 3558-3564). The decomposition of THF may cause a small amount of S-O exchange, resulting in a ³¹P resonance shift at 83.9 ppm, which is assigned to a glassy phase of both monomeric (PS₄)³ and (PS₃O)³ units.

Computational and experimental studies have explored the use of oxysulfides to combine the desirable electrochemical properties of oxide and sulfide materials individually. Recent experimental support of enhancements has been reported on Li₁₀SiP₂S₁₂₋ₓOₓ, showing an increase in ionic conductivity when x=0.7 and that a crystalline PS₄₋ₓOₓ unit is generated from the β-Li₃PS₄ impurity (K.-H. Kim, et al. Chem. Mater. 2019, 31, 3984-3991).

In Li₃PS₄₋ₓOₓ, O has a smaller radius and greater electronegativity than S, making the P—O bond shorter in length than P—S bonds. Therefore, according to computational studies, the O ion can create an empty region near itself for Li-ions to move efficiently through (X. Wang, et al. Phys. Chem. Chem. Phys. 2016, 18, 21269-21277). Specifically, oxygen substitution may permit the connection of 2D channels, which generate a 3D Li-ion transport pathway by joining the 8d and 4b sites.

For sulfides, and their corresponding oxygenated phases, the method of synthesis may have an impact on the resulting material's overall electrochemical properties. High temperature, highly conducting metastable phases, which are stable at room temperature, can be beneficial to electrochemical performance. They also can be acquired using a quench method, however, this requires heating temperatures of >900° C. to synthesize Li₃PS₄ (K. Takada, et al. Solid State Ionics 2005, 176, 2355-2359).

Another possible technique is high-energy ball milling (see, e.g., T. Famprikis et al. Nat. Mater. 2019, 18, 1278-1291; A. Düvel, et al. J. Phys. Chem. C 2011, 115, 23784-23789; and K. Kanazawa et al. Inorg. Chem. 2018, 57, 9925-9930), which can access high temperature metastable phases in a manner similar to quenching. Kinetic energy of zirconia balls that collide with the chemical precursors may cause rapid heating and cooling, therefore yielding a glass with a “frozen” high-temperature atomic configuration. This may result in a metastable phase that can be crystallized from the glass matrix, usually from optimized thermal treatment, which typically gives a glass-ceramic material.

There remains a need for improved solid electrolytes, lithium-ion batteries that include solid electrolytes, and methods for producing solid electrolytes, including solid electrolytes having improved conductivity, stability, and safety when used in lithium-ion batteries.

### BRIEF SUMMARY

Provided herein are electrolytes, such as solid electrolytes, lithium-ion batteries, and methods for producing solid electrolytes that overcome one or more of the foregoing disadvantages. The electrolytes provided herein, which may include glass-ceramic electrolytes, may have improved activation energies, conductivities, stability, or a combination thereof.

In one aspect, electrolytes are provided. The electrolytes may be solid electrolytes. The electrolytes may be glass-ceramic electrolytes. In some embodiments, the electrolytes include a material of formula (I): Li₃PS₄₋ₓOₓ, wherein x is 0<x≤1.

In another aspect, lithium-ion batteries are provided. In some embodiments, the lithium-ion batteries include an electrolyte described herein, such as an electrolyte comprising a composition of formula (I).

In yet another aspect, methods of forming electrolytes are provided. In some embodiments, the methods of forming the electrolytes include contacting Li₂S, P₂S₅, and P₂O₅ to form the electrolytes. The contacting of Li₂S, P₂S₅, and P₂O₅ may include (i) mixing Li₂S, P₂S₅, and P₂O₅, (ii) homogenizing Li₂S, P₂S₅, and P₂O₅ under vacuum, or (iii) a combination thereof.

Additional aspects will be set forth in part in the description which follows, and in part will be obvious from the description, or may be learned by practice of the aspects described herein. The advantages described herein may be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

FIG. 1A depicts powder X-ray diffraction (PXRD) patterns of embodiments of Li₃PS₄₋ₓOₓ and β-Li₃PS₄.

FIG. 1B depicts a plot of ΔHₘᵢₓ of embodiments of Li₃PS₄₋ₓOₓ.

FIG. 2 depicts PXRD patterns of embodiments of Li₃PS₄₋ₓOₓ.

FIG. 3A depicts 6Li nuclear magnetic resonance (NMR) spectra for Li₃PS₄₋ₓOₓ.

FIG. 3B depicts ⁶Li quantitative analysis for embodiments of Li₃PS₄₋ₓOₓ.

FIG. 4A depicts experimental ⁶Li spectra and deconvolution of Li₃PS₄, Li₃PS_{3.9}O_{0.1}, Li₃PS_{3.75}O_{0.25}, and Li₃PS_{3.69}O_{0.31}.

FIG. 4B depicts experimental ³¹P spectra and deconvolution for Li₃PS₄, Li₃PS_{3.9}O_{0.1}, Li₃PS_{3.75}O_{0.25}, and Li₃PS_{3.69}O_{0.31}.

FIG. 4C depicts simulated ⁶Li spectra for Li₃PS₄, Li₃PS_{3.875}O_{0.125}, and Li₃PS_{3.75}O_{0.25}.

FIG. 4D depicts simulated ³¹P spectra for Li₃PS₄, Li₃PS_{3.875}O_{0.125}, and Li₃PS_{3.75}O_{0.25}.

FIG. 5 depicts a plot of ⁷Li spin-lattice relaxation times, T₁, for embodiments of Li₃PS₄₋ₓOₓ, (x=0,0.1, 0.25, and 0.31).

FIG. 6A depicts ³¹P magic angle spinning (MAS) NMR spectra for x in embodiments of Li₃PS₄₋ₓOₓ.

FIG. 6B depicts ³¹P quantitative analysis for embodiments of Li₃PS₄₋ₓOₓ, (x=0, 0.1, 0.25, and 0.31).

FIG. 7A depicts conductivity isotherms from-40° C. to 120° C. of Li₃PS_{3.69}O_{0.31}.

FIG. 7B depicts an Arrhenius plot for x in Li₃PS₄₋ₓO₂ using the Arrhenius relation between ØDC and inverse temperature to calculate E_{a,DC}.

FIG. 8A depicts a Nyquist plot of Li₃PS₄ at −40° C.

FIG. 8B depicts a Nyquist plot of Li₃PS_{3.9}O_{0.1} at −40° C.

FIG. 8C depicts a Nyquist plot of Li₃PS_{3.75}O_{0.25} at −40° C.

FIG. 8D depicts a Nyquist plot of Li₃PS_{3.6900.31} at −40° C.

FIG. 8E depicts a Nyquist plot of Li₃PS_{3.500.5} at −40° C.

FIG. 8F depicts a Nyquist plot of Li₃PS₃O at −40° C.

FIG. 9A depicts conductivity isotherms (σ′) of embodiments of Li₃PS₄ acquired from −40° C. to 120° C.

FIG. 9B depicts conductivity isotherms (σ′) of embodiments of Li₃PS_{3.9}O_{0.1} acquired from −40° C. to 120° C.

FIG. 9C depicts conductivity isotherms (σ′) of embodiments of Li₃PS_{3.75}O_{0.25} acquired from −40° C. to 120° C.

FIG. 9D depicts conductivity isotherms (σ′) of embodiments of Li₃PS_{3.69}O_{0.31} acquired from −40° C. to 120° C.

FIG. 9E depicts conductivity isotherms (σ′) of embodiments of Li₃PS_{3.5}O_{0.5} acquired from −40° C. to 120° C.

FIG. 9F depicts conductivity isotherms (σ′) of embodiments of Li₃PS₃O₁ acquired from −40° C. to 120° C.

FIG. 10A depicts Arrhenius plots for x in embodiments of Li₃PS₄₋ₓOₓ.

FIG. 10B depicts the number of Li with varying Li-Li distance for embodiments of Li₃PS₄₋ₓOₓ.

FIG. 11A depicts the frequency dependence of M″ (the imaginary part of the complex electric modulus) of Li₃PS_{3.69}O_{0.31}.

FIG. 11B depicts the temperature dependence of τM″⁻¹ of Li₃PS₄₋ₓOₓ (x=0, 0.1, 0.25, 0.31, 0.5, and 1).

FIG. 12 depicts the normalized crossover frequency, ω_{c}, of Li₃PS₄₋ₓOₓ (x=0, 0.1, 0.25, 0.31, 0.5, and 1).

FIG. 13 depicts fractions of Li exhibiting MSC>5 Å² from the 600K ab initio molecular dynamics (AIMD) trajectory of 200 ps with respect to x in Li₃PS₄₋ₓOₓ.

FIG. 14A depicts the real part of resistivity (ρ′) of Li₃PS_{3.69}O_{0.31} as a function of inverse temperature.

FIG. 14B depicts the temperature dependence of ρ′ of Li₃PS₄₋ₓOₓ (x=0, 0.1, 0.25, 0.31, 0.5, and 1) when measured at 1 MHz.

FIG. 15 depicts VT-EIS summary for x in Li₃PS₄₋ₓOₓ.

FIG. 16A depicts the radial pair distribution function of S—Li and O—Li bond pairs for varying concentrations of oxygen in Li₃PS₄₋ₓOₓ.

FIG. 16B depicts the number of Li(n_{Li}) surrounding S and O within a first coordination shell.

FIG. 17A depicts Li spatial density with respect to the Li-Li distance parameter for embodiments of electrolytes herein.

FIG. 17B depicts Arrhenius plots of Li₃PS₃O localized and dispersed.

### DETAILED DESCRIPTION

Provided herein are electrolytes, batteries, and methods for making electrolytes, such as the electrolytes described herein.

### Electrolytes and Batteries

In some embodiments, the electrolytes provided herein include a material of formula (I):

Li₃PS₄₋ₓOₓ formula (I);

wherein x is 0<x≤1.

In some embodiments, the electrolyes provided herein include a material of formula (I), wherein 0<x<1, 0<x<0.9, 0<x<0.8, 0<x<0.7, 0<x<0.6, 0<x<0.5, 0<x<0.4, 0<x<0.35, 0<x<0.31, 0<x<0.3, 0<x<0.25, 0<x<0.2, 0<x<0.15, or 0<x<0.1.

In some embodiments, the electrolyes provided herein include a material of formula (I), wherein 0<x≤1, 0<x≤0.9, 0<x≤0.8, 0<x≤0.7, 0<x≤0.6, 0<x≤ 0.5,0<x≤0.4, 0<x≤0.35, 0<x≤0.31, 0<x≤0.3, 0<x≤0.25, 0<x≤0.2, 0<x≤0.15, or 0<x<0.1.

In some embodiments, the electrolyes provided herein include a material of formula (I), wherein 0.1<x<1, 0.15<x<1, 0.2<x<1, 0.25<x<1, 0.3<x<1,0.31<x<1.

In some embodiments, the electrolyes provided herein include a material of formula (I), wherein 0.1<x≤1, 0.15<x≤1, 0.2<x≤1, 0.25<x≤1, 0.3<x≤1,, or 0.31<x≤1.

In some embodiments, the electrolyes provided herein include a material of formula (I), wherein 0.1<x<0.5, 0.15<x<0.5, 0.2<x<0.5, 0.25<x<0.5, 0.3<x<0.5, 0.31<x<0.5.

In some embodiments, the electrolyes provided herein include a material of formula (I), wherein 0.1<x≤0.5, 0.15<x≤0.5, 0.2<x≤0.5, 0.25<x≤0.5,0.3<x≤0.5, 0.31<x≤0.5.

In some embodiments, the electrolytes provided herein include a material of formula (I), wherein x is 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.4, 0.41, 0.42, 0.43, 0.44, 0.45, 0.46, 0.47, 0.48, 0.49, 0.5, 0.51, 0.52, 0.53, 0.54, 0.55, 0.56, 0.57, 0.58, 0.59, 0.6, 0.61, 0.62, 0.63, 0.64, 0.65, 0.66, 0.67, 0.68, 0.69, 0.7, 0.71, 0.72, 0.73, 0.74, 0.75, 0.76, 0.77, 0.78, 0.79, 0.8, 0.81, 0.82, 0.83, 0.84, 0.85, 0.86, 0.87, 0.88, 0.89, 0.9, 0.91, 0.92, 0.93, 0.94, 0.95, 0.96, 0.97, 0.98, or 0.99.

In some embodiments, the electrolyte consists of a material of formula (I).

The electrolytes provided herein may be in any physical form. The electrolytes, for example, may be solid electrolytes. The solid electrolytes may be glass-ceramic electrolytes. As used herein, the phrase “glass-ceramic electrolyte” refers to an electrolyte having at least one type of functional crystalline phase and a residual glass. The solid electrolytes may be in the form of a powder. The solid electrolytes may be in the form of a pellet. The pellet may have any density that is suitable for a desired application, such as lithium-ion batteries. In some embodiments, the solid electrolytes, such as the solid electrolytes in the form of a pellet, have a density of about 1 g/cm³ to about 3 g/cm³, about 1.5 g/cm³ to about 2.5 g/cm³, or about 1.5 g/cm³ to about 2 g/cm³.

In some embodiments, x is greater than 0, and the electrolye has an activation energy that is less than an activation energy of β-Li₃PS₄. The activation energy, for example, may be at least 1%, at least 3%, at least 5%, at least 10%, at least 20%, or at least 25% less than an activation energy of β-Li₃PS₄.

In some embodiments, x is greater than 0, and the electrolyte has an ionic conductivity that is at least 3 times, at least 4 times, at least 5 times, at least 6 times, at least 7 times, or at least 10 times greater than an ionic conductivity of β-Li₃PS₄.

Also provided herein are batteries that include one or more electrolytes provided herein. In some embodiments, the battery is a lithium-ion battery. The batteries may include an anode, a cathode, and an electrolyte described herein. The electrolyte may be arranged between the anode and the cathode.

### Methods

Also provided herein are methods of forming electrolytes. In some embodiments, the methods include contacting Li₂S, P₂S₅, and P₂O₅ to form an electrolyte. When the methods are used to produce electrolytes that include a compostion of formula (I), the ratios of Li₂S, P₂S₅, and P₂O₅ that are contacted may be selected to achieve a desired value for “x” of formula (I).

The Li₂S, P₂S₅, and P₂O₅ may be contacted using any known technique. In some embodiments, the contacting of Li₂S, P₂S₅, and P₂O₅ includes (i) mixing Li₂S, P₂S₅, and P₂O₅, (ii) homogenizing Li₂S, P₂S₅, and P₂O₅ under vacuum, or (iii) a combination thereof.

The homogenizing of Li₂S, P₂S₅, and P₂O₅ under vacuum may include milling Li₂S, P₂S₅, and P₂O₅ with a milling media, wherein a weight ratio of the milling media to the total weight of Li₂S, P₂S₅, and P₂O₅ is about 10:1 to about 20:1, about 12:1 to about 18:1, about 12:1 to about 16:1, about 13:1 to about 15:1, or about 14:1. As used herein, the term “milling” refers to crushing, grinding, or a combination thereof, and the phrase “milling media” refers object(s) used to crush and/or grind. Non-limiting examples of milling media that may be used in the methods herein include one or more three-dimensional objects, such as balls, cylinders, etc., which may be formed of metal, ceramic, glass, etc.

In some embodiments, the methods also include pressing an electrolyte, such as an electrolyte in powder form, into a pellet. The pressing of the elecrolyte, such as an electrolyte in powder form, into a pellet includes subjecting the electrolyte to a pressure of at least 100 MPa, at least 150 MPa, at least 200 MPa, at least 250 MPa, or at least 300 MPa, and a temperature of at least 100° C., at least 150° C., at least 200° C., at least 250° C., or at least 300° C. The electrolyte may be subjected to the pressure and the temperature simultaneously, sequentially, or a combination thereof.

### Embodiments

The following listing provides non-limiting embodiments of the electrolytes, batteries, and methods provided herein:

Embodiment 1. An electrolyte comprising a material of formula (I):

Li₃PS₄₋ₓOₓ formula (I);

wherein x is 0<x≤1.

Embodiment 2. The electrolyte of Embodiment 1, wherein 0<x<1, 0<x<0.9, 0<x<0.8, 0<x<0.7, 0<x<0.6, 0<x<0.5, 0<x<0.4, 0<x<0.35, 0<x<0.31, 0<x<0.3, 0<x<0.25, 0<x<0.2, 0<x<0.15, or 0<x<0.1.

Embodiment 3. The electrolyte of Embodiment 1, wherein 0<x≤1, 0<x≤ 0.9, 0<x≤0.8, 0<x<0.7,0<x<0.6,0<x<0.5,0<x<0.4,0<x<0.35,0<x<0.31,0<x<0.3, 0<x<0.25, 0<x<0.2, 0<x<0.15, or 0<x≤0.1.

Embodiment 4. The electrolyte of Embodiment 1, wherein 0.1<x<1, 0.15<x<1, 0.2<x<1,0.25<x<1,0.3<x<1,0.31<x<1.

Embodiment 5. The electrolyte of Embodiment 1, wherein 0.1<x≤1, 0.15<x<1, 0.2<x≤1, 0.25<x≤1, 0.3<x<1,, or 0.31<x≤1.

Embodiment 6. The electrolyte of Embodiment 1, wherein 0.1<x<0.5, 0.15<x<0.5, 0.2<x<0.5, 0.25<x<0.5, 0.3<x<0.5, 0.31<x<0.5.

Embodiment 7. The electrolyte of Embodiment 1, wherein 0.1<x≤0.5, 0.15<x≤0.5, 0.2<x≤0.5,0.25<x≤0.5,0.3<x≤0.5,0.31<x≤0.5.

Embodiment 8. The electrolyte of Embodiment 1, wherein x is 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.4, 0.41, 0.42, 0.43, 0.44, 0.45, 0.46, 0.47, 0.48, 0.49, 0.5, 0.51, 0.52, 0.53, 0.54, 0.55, 0.56, 0.57, 0.58, 0.59, 0.6, 0.61, 0.62, 0.63, 0.64, 0.65, 0.66, 0.67, 0.68, 0.69, 0.7, 0.71, 0.72, 0.73, 0.74, 0.75, 0.76, 0.77, 0.78, 0.79, 0.8, 0.81, 0.82, 0.83, 0.84, 0.85, 0.86, 0.87, 0.88, 0.89, 0.9, 0.91, 0.92, 0.93, 0.94, 0.95, 0.96, 0.97, 0.98, or 0.99.

Embodiment 9. The electrolyte of any one of Embodiments 1 to 8, wherein the electrolyte consists of the material of formula (I).

Embodiment 10. The electrolyte of any one of Embodiments 1 to 9, wherein the electrolyte is a solid electrolyte.

Embodiment 11. The electrolyte of Embodiment 10, wherein the solid electrolyte is a glass-ceramic electrolyte.

Embodiment 12. The electrolyte of Embodiment 10 or 11, wherein the electrolye is in the form of a powder.

Embodiment 13. The electrolyte of any of Embodiments 1 to 12, wherein the electrolye is in the form of a pellet.

Embodiment 14. The electrolyte of Embodiment 13, wherein the pellet has a density of about 1 g/cm³ to about 3 g/cm³, about 1.5 g/cm³ to about 2.5 g/cm³, or about 1.5 g/cm³ to about 2 g/cm³.

Embodiment 15. The electrolyte of any of Embodiments 1 to 14, wherein x is greater than 0, and the electrolye has an activation energy that is less than an activation energy of β-Li₃PS₄.

Embodiment 16. The electrolyte of Embodiment 15, wherein the activation energy is at least 1%, at least 3%, at least 5%, at least 10%, at least 20%, or at least 25% less than an activation energy of β-Li₃PS₄.

Embodiment 17. The electrolyte of any of Embodiments 1 to 16, wherein x is greater than 0, and the electrolyte has an ionic conductivity that is at least 3 times, at least 4 times, at least 5 times, at least 6 times, at least 7 times, or at least 10 times greater than an ionic conductivity of β-Li₃PS₄.

Embodiment 18. A battery including an electrolyte of any of Embodiments 1 to 17.

Embodiment 19. The battery of Embodiment 18, wherein the battery is a lithium-ion battery.

Embodiment 20. A method forming an electrolyte, such as an electrolyte of any of Embodiments 1 to 17, wherein the method includes contacting Li₂S, P₂S₅, and P₂O₅ to form the electrolyte.

Embodiment 21. The method of Embodiment 20, wherein the contacting of Li₂S, P₂S₅, and P₂O₅ comprises (i) mixing Li₂S, P₂S₅, and P₂O₅, (ii) homogenizing Li₂S, P₂S₅, and P₂O₅ under vacuum, or (iii) a combination thereof.

Embodiment 22. The method of Embodiment 20 or 21, wherein the homogenizing of Li₂S, P₂S₅, and P₂O₅ under vacuum comprises milling Li₂S, P₂S₅, and P₂O₅ with a milling media.

Embodiment 23. The method of Embodiment 22, wherein a weight ratio of the milling media to the total weight of Li₂S, P₂S₅, and P₂O₅ is about 10:1 to about 20:1, about 12:1 to about 18:1, about 12:1 to about 16:1, about 13:1 to about 15:1, or about 14:1.

Embodiment 24. The method of any of Embodiments 20 to 23, wherein the method further comprises pressing the electrolyte into a pellet.

Embodiment 25. The method of Embodiment 24, wherein the pressing of the elecrolyte, such as an electrolyte in powder form, into a pellet includes subjecting the electrolyte to a pressure of at least 100 MPa, at least 150 MPa, at least 200 MPa, at least 250 MPa, or at least 300 MPa, and a temperature of at least 100° C., at least 150° C., at least 200° C., at least 250° C., or at least 300° C.

Embodiment 26. The method of Embodiment 25, wherein the electrolyte is subjected to the pressure and the temperature simultaneously, sequentially, or a combination thereof.

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

While certain aspects of conventional technologies have been discussed to facilitate disclosure of various embodiments, applicants in no way disclaim these technical aspects, and it is contemplated that the present disclosure may encompass one or more of the conventional technical aspects discussed herein.

The present disclosure may address one or more of the problems and deficiencies of known methods and processes. However, it is contemplated that various embodiments may prove useful in addressing other problems and deficiencies in a number of technical areas. Therefore, the present disclosure should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

In the descriptions provided herein, the terms “includes,” “is,” “containing,” “having,” and “comprises” are used in an open-ended fashion, and thus should be interpreted to mean “including, but not limited to.” When methods or apparatuses are claimed or described in terms of “comprising” various steps or components, the methods or apparatuses can also “consist essentially of” or “consist of” the various steps or components, unless stated otherwise.

The terms “a,” “an,” and “the” are intended to include plural alternatives, e.g., at least one. For instance, the disclosure of “an electrolyte,” “a pellet,” “a powder”, and the like, is meant to encompass one, or mixtures or combinations of more than one electrolyte, pellet, powder, and the like, unless otherwise specified.

Various numerical ranges may be disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. Moreover, all numerical end points of ranges disclosed herein are approximate. As a representative example, Applicant discloses, in some embodiments, that the pellet may have a density of about 1.5 g/cm³ to about 2 g/cm³. This range should be interpreted as encompassing about 1.5 g/cm³ to about 2 g/cm³, and further encompasses “about” each of 1.6 g/cm³, 1.7 g/cm³, 1.8 g/cm³, and 1.9 g/cm³, including any ranges and sub-ranges between any of these values.

As used herein, the term “about” means plus or minus 10% of the numerical value of the number with which it is being used.

### EXAMPLES

The present invention is further illustrated by the following examples, which are not to be construed in any way as imposing limitations upon the scope thereof. On the contrary, it is to be clearly understood that resort may be had to various other aspects, embodiments, modifications, and equivalents thereof which, after reading the description herein, may suggest themselves to one of ordinary skill in the art without departing from the spirit of the present invention or the scope of the appended claims. Thus, other aspects of this invention will be apparent to those skilled in the art from consideration of the specification and practice of the invention disclosed herein.

### Example 1—Synthesis of Li₃PS₄Oₓ

This example provides a solid-state synthesis of Li₃PS₄₋ₓOₓ, wherein x=0.31, which yielded a sevenfold increase in ionic conductivity and a lower activation energy compared to experimental β-Li₃PS₄. Detailed variable temperature electrochemical impedance spectroscopy (EIS) analysis was implemented to probe the short-range and long-range Li-ion motion and Arrhenius prefactor.

In addition, the Jonscher-type power law exponent was computed to confirm the enhanced dimensionality of Li-ion motion in Li₃PS₄₋ₓOₓ compared to the experimental β-Li₃PS₄. Li₃PS₄₋ₓOₓ were investigated using PXRD to confirm the β-Li₃PS₄ phase at room temperature in addition to ⁶Li and ³¹P MAS NMR to elucidate the change in local structure. Computational studies using AIMD simulations were also carried out to understand the cause of the enhanced conductivity and decreased activation energy. These results, as explained below, showed that optimal amounts of oxygen substitution with respect to electrochemical performance could yield 3D Li-ion transport pathways and an intrinsic concentration gradient of Li, giving widened Li channels.

In this example, Li₃PS_{3.69}O_{0.31} was synthesized, and the Li₃PS_{3.69}O_{0.31} had an ionic conductivity of 1.38 mS/cm at 25° C., which was 7 times greater than that of pristine β-Li₃PS₄.

Detailed analysis of variable-temperature EIS and solid-state NMR showed that the enhanced Li-ion conduction could likely be ascribed to a transition from 2D to 3D Li-ion motion upon oxygen substitution, due to the formation of a (PS₃ₓOₓ)³⁻ unit.

Further oxygen substitution likely caused the evolution of lithium phosphate impurities, which probably contributed to a decline in ionic conductivity. Computational studies to understand the origin of this enhancement supported the enhancement in dimensionality of Li-ion motion also, likely due to a wider Li channel attributed to the intrinsic Li concentration gradient up to a critical oxygen concentration.

All chemicals were used as received. Stoichiometric amounts of Li₂S (Alfa Acsar, 99.9%), P₂S₅ (Sigma-Aldrich, 99.9%), and P₂O₅ (Alfa Acsar, 99.99%) were gently mixed using Agar mortar and pestle for 10 m and then homogenized for 10 h under vacuum using a SPEX 8000M high energy mixer. The ratio of the milling media (two zirconia balls; Ø_{OD}=10 mm) to the total weight of precursors was roughly 14:1. The mixed powders were pressed into a 6-mm diameter pellet (Across International) under a pressure of ˜400 MPa and then heated at 230° C. for 2 h (ramping rate of 1° C./minute) followed by natural cooling. The approximate pellet density used was 1.8 g/cm³. Sample handling and heat treatment were all performed under Ar (H₂O<1 ppm and O₂<1 ppm) in glovebox.

Materials Characterization. Impedance measurements on Li₃PS₄₋ₓOₓ were carried out using a Gamry Ref 600⁺ and home-built PEEK cylindrical cell with indium foil as blocking electrodes. Variable-temperature Nyquist spectra were collected from −40° C. to 120° C. (increment of 10° C. per measurement, except 25° C.) within a scanning frequency range from 5 MHz to 1 Hz under a biased potential of 100 mV.

All the measurements were performed in a Cincinnati Sub-Zero Temperature Chamber under dry air atmosphere to prevent H₂O contamination. PXRD measurements were conducted with a PANalytical X′Pert Pro-MPD Powder Diffractometer with Cu-K_{α} radiation. KAPTON® film was employed to reduce reactions of Li₃PS₄₋ₓOₓ with moist air. MAS NMR measurements on Li₃PS₄₋ₓOₓ were performed on a Bruker Avance III 500 MHZ NMR spectrometer with a spinning rate of 25 kHz at room temperature. ³¹P (Larmor frequency=202.404 MHZ) NMR spectra were acquired using a Hahn Echo pulse sequence with a pulse length of 4.200 μs and a recycle delay of 200 s. A single pulse with a pulse length of 4.750 μs was employed to obtain ⁶Li (Larmor frequency=73.58 MHZ) NMR spectra using a recycle delay of 200 s). ⁷Li spin-lattice relaxation time was performed using an inversion recovery pulse sequence. ⁶Li and ³¹P chemical shift were referenced to solid LiCl (−1.1 ppm) and to 85% H₃PO₄ (0 ppm), respectively.

### Example 2—Calculations

The structure of β-Li₃PS₄ was taken from Materials Project (ID: mp-985583). Vienna ab initio simulation package (VASP) was used for density functional theory (DFT) energy calculations with the projector-augmented-wave method (see, e.g., P. E. Blöchl, Physical Review B 1994, 50, 17953-17979; G. Kresse, J. Furthmüller, Physical Review B 1996, 54, 11169-11186) in Perdew-Burke-Ernzerhof generalized-gradient approximation (PBE-GGA) (J. P. Perdew, K. Burke, M. Ernzerhof, Physical Review Letters 1996, 77, 3865-3868). An energy cutoff of 520 cV and a k-point density of around 800 per number of atoms in the unit cell were used for all computations. The software suite pymatgen was employed to order the 25 structures of O-substituted Li₃PS₄ at different substitution levels with the lowest energy determined by electrostatic interaction (S. P. Ong, W. D. Richards, A. Jain, G. Hautier, M. Kocher, S. Cholia, D. Gunter, V. L. Chevrier, K. A. Persson, G. Ceder, Computational Materials Science 2013, 68, 314-319). The energy above hull for each structure was calculated based on the database of Materials Project after DFT energy was obtained from the geometry optimization on VASP. All the other parameters involved were the same as default settings in pymatgen. The isotropic chemical shifts were calculated by magnetic shieldings using perturbation theory (linear response)(C. J. Pickard, F. Mauri, Phys. Rev. B 2001, 63, 245101; and J. R. Yates, C. J. Pickard, F. Mauri, Phys. Rev. B 2007, 76, 024401). The calibration factors of ^{6/7}Li (+90.5 ppm) and ³¹P (+254 ppm) were estimated from the difference between experimental and calculated isoshift of pristine β-Li₃PS₄. All the configurations that were selected for NMR calculations had the lowest total energy among all the DFT-optimized structures of the same O doping level. An energy cutoff of 600 eV was applied to the system to meet the high-accuracy criterion for such calculations. For better visualization, Lorenzen line-broadening was conducted with broadening factors listed in the following table:

Summary of simulated Lorenzen line-broadening factors of
different peaks in Li₃PS₄₋ₓOₓ (x = 0, 0.125, 0.25).

| | | | Modified | | |
|---|---|---|---|---|---|
| Sample | Li½ | Li3 | Li | γ-PS₄³⁻ | PS₃O³⁻ |
| Li₃PS₄ | 0.9 | 0.5 | 0.95 | 1 | N/A |
| Li₃PS_{3.875}O_{0.125} | 0.9 | 0.5 | 0.95 | 2 | 4.2 |
| Li₃PS_{3.75}O_{0.25} | 0.9 | 0.5 | 0.95 | 10.5 | 8 |

Line-broadening was more significant for calculated results since they were determined at 0 K and no ion exchange was simulated. At room temperature, rapid Li⁺ ion exchange reduced line width of NMR peaks.

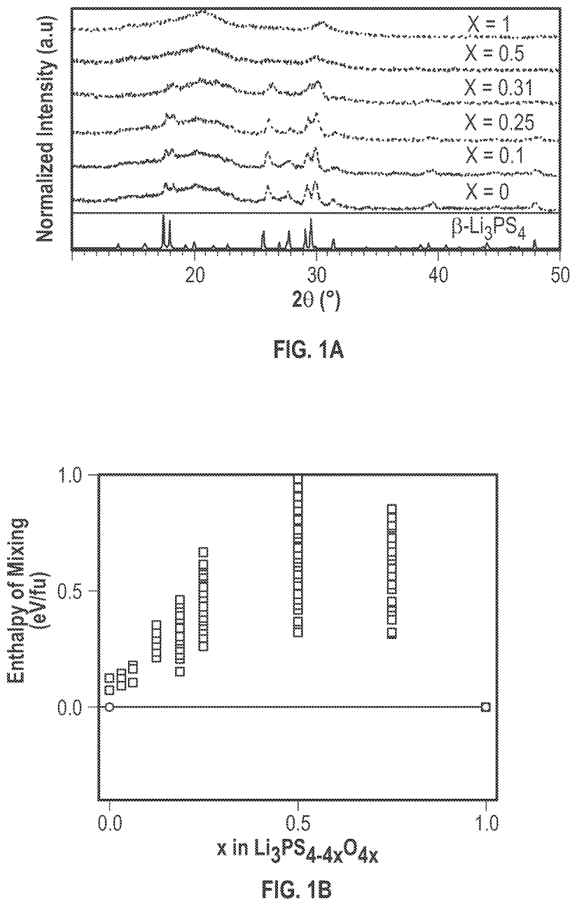

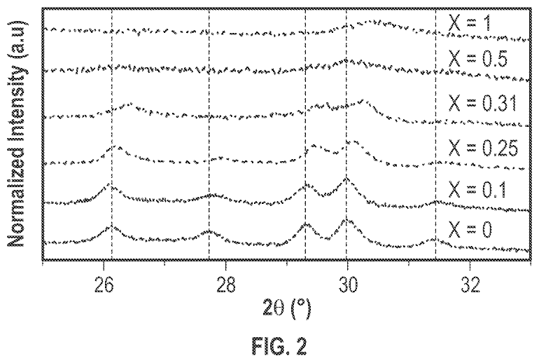

FIG. 1A shows the PXRD patterns of Li₃PS₄₋ₓOₓ (x=0, 0.1, 0.25, 0.31, 0.5, and 1) at room temperature. No obvious phase other than β-Li₃PS₄ was identified up to x=0.31 in Li₃PS₄₋ₓOₓ, suggesting the average structures of Li₃PS₄₋ₓOₓ (x=0, 0.1, 0.25, 0.31) were similar. A successful replacement of S with O, as depicted at FIG. 2, manifested the shift in diffraction peaks to higher angles (2θ) upon incorporation of oxygen into the β-Li₃PS₄, indicating a contraction of the crystal lattice.

FIG. 2 depicts PXRD patterns of Li₃PS₄₋ₓOₓ (x=0, 0.1, 0.25,0.31, 0.5, and 1). A gradual shift of diffraction peaks to higher angles (2θ) upon oxygen substitution was observed, which confirmed successful incorporation of O into-Li₃PS₄ structure. Dash lines are guide-to-eye.

The broadening in diffraction peaks with low intensity indicated that Li₃PS₄₋ₓOₓ was glass-ceramic. When x was higher than 0.31 in Li₃PS₄₋ₓOₓ, a further reduction of crystallinity lead to an almost featureless powder pattern, which made the phase identification challenging. The change in long-range order from glass-ceramic to nearly glass in Li₃PS₄₋ₓOₓ could be explained by the enthalpy of mixing, ΔHₘᵢₓ calculations. As shown in FIG. 1B, the ΔHₘᵢₓ in both Li₃PS_{3.5}O_{0.5} and Li₃PS₃₀₁ was larger than in Li₃PS_{3.875}O_{0.125} and Li₃PS_{3.75}O_{0.25}. In general, the larger the ΔHₘᵢₓ, the more a composition was assumed to be unstable; hence, decomposing to thermodynamically more stable phases. Therefore, FIG. 1B depicts the stability of β-Li₃PS₄₋ₓOₓ as reflected by ΔHₘᵢₓ. Each square marker indicates a distinct structural configuration. The terminal compounds, Li₃PS₄ and Li₃PO₄, were thermodynamically the most stable phases.

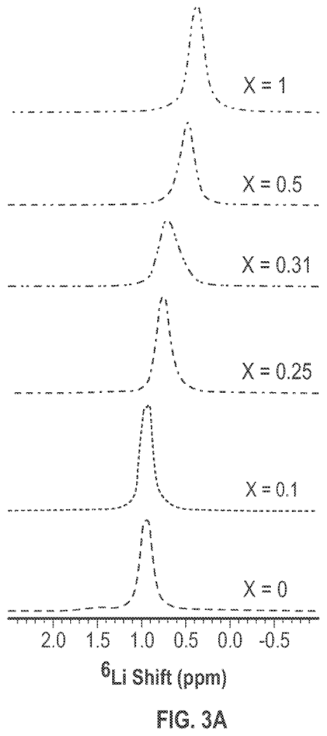

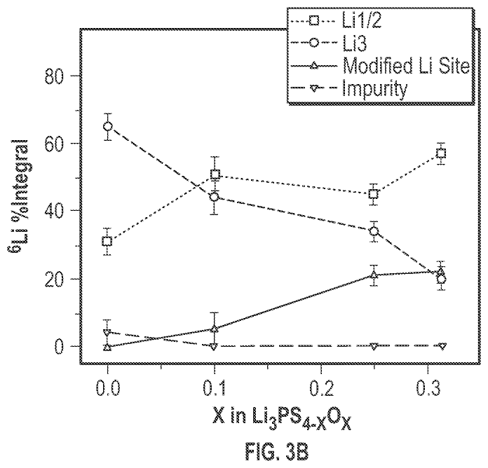

To understand the structural evolution of local environment due to oxygen substitution in Li₃PS₄₋ₓOₓ, ⁶Li and ³¹P solid-state NMR was employed. As shown at FIG. 3A, ⁶Li MAS (25 kHz) NMR spectra revealed a significant upfield shift (smaller ppm) upon oxygen substitution, indicating the Li⁺ local environment became more ionic. FIG. 3A depicts ⁶Li NMR spectra for Li₃PS₄₋ₓOₓ (x=0, 0.1, 0.25, 0.31, 0.5, and 1).

Since there was a large loss of crystallinity for higher oxygenated samples, deconvolution was only performed on Li₃PS₄, Li₃PS_{3.9}O_{0.1}, Li₃PS_{3.75}O_{0.25}, and Li₃P3.69O_{0.31} as shown at FIG. 3A, with the corresponding quantitative analysis shown in FIG. 3B. FIG. 3B depicts ⁶Li quantitative analysis for Li₃PS₄₋ₓOₓ (x=0, 0.1, 0.25, 0.31).

For Li₃PS₄, there were three peaks assigned, one was the combined Lil/Li₂ site which corresponded to the 8d and 4b Wyckoff sites respectively and were assigned together due to their close distance and fast exchange (H. Stöffler, T. Zinkevich, M. Yavuz, A. Senyshyn, J. Kulisch, P. Hartmann, T. Adermann, S. Randau, F. H. Richter, J. Janck, et al., J. Phys. Chem. C 2018, 122, 15954-15965). The other was the Li₃ site, which corresponded to the 4c Wyckoff site.

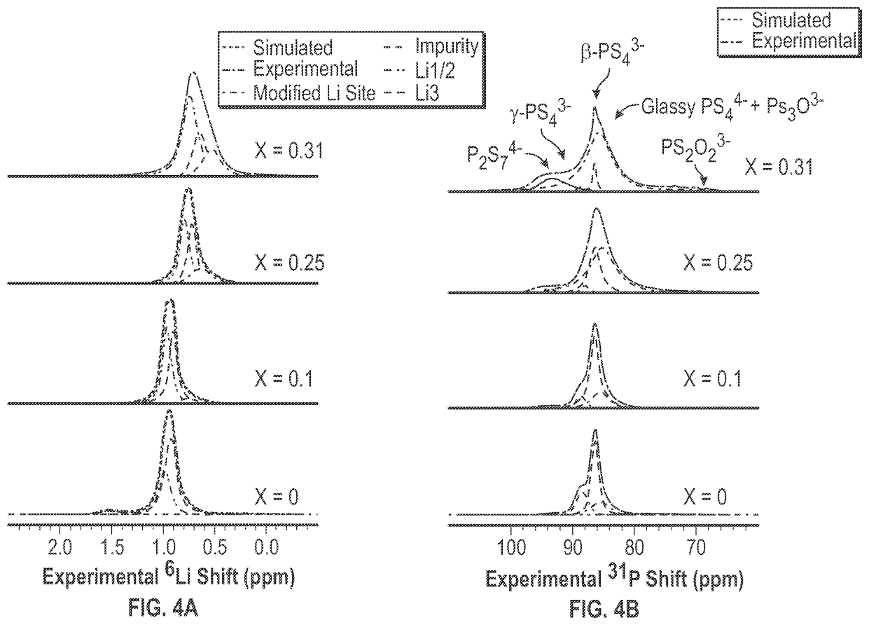

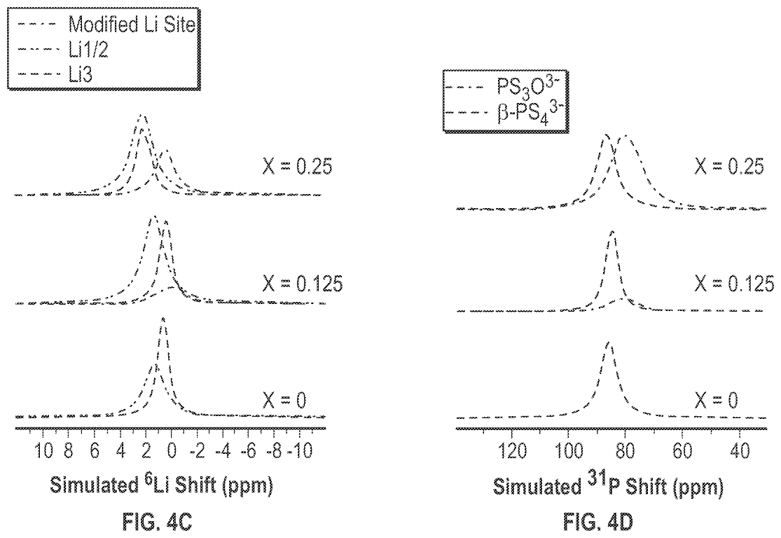

The last peak was at 1.5 ppm and was assigned to an unknown impurity, comprising 4% integral total. With increasing oxygen substitution, the impurity decreased to a negligible amount. In addition, the ⁶Li integral % of the combined Li 1/2 assignment increased with a maximum for Li₃P3.69O_{0.31}. A decrease in the ⁶Li integral % of the Li₃ site occurred and the emergence of a new Li site (modified Li site) could be seen. This modified Li site was expected to promote long-range 3D Li-ion conduction and composed of Li in an off-centered tetrahedral site due to its bond with O. Isotropic ⁶Li chemical shifts were simulated using perturbation theory for Li₃PS₄, Li₃PS_{3.875}O_{0.125}, and Li₃PS_{3.75}O_{0.25} from DFT optimized structures of the same composition (FIG. 4C). The results showed good agreement with the experimental data and further supported successful oxygenation.

FIG. 4A depicts experimental ⁶Li spectra and deconvolution of Li₃PS₄, Li₃PS_{3.9}O_{0.1}, Li₃PS_{3.75}O_{0.25}, and Li₃PS_{3.69}O_{0.31}. FIG. 4B depicts experimental ³¹P spectra and deconvolution for Li₃PS₄, Li₃PS_{3.9}O_{0.1}, Li₃PS_{3.75}O_{0.25}, and Li₃PS_{3.69}O_{0.31}. FIG. 4C depicts simulated ⁶Li spectra for Li₃PS₄, Li₃PS_{3.875}O_{0.125}, and Li₃PS_{3.75}O_{0.25}. FIG. 4D depicts simulated ³¹P spectra for Li₃PS₄, Li₃PS_{3.875}O_{0.125}, and Li₃PS_{3.75}O_{0.25}.

To study the change in Li-ion mobility upon oxygen substitution, ⁷Li spin-lattice relaxation time, T₁, for Li₃PS₄, Li₃PS_{3.9}O_{0.1}, Li₃PS_{3.75}O_{0.25}, and Li₃P3.69O_{0.31} was performed as depicted at FIG. 5. T₁ was the time required for a spin to restore its longitudinal magnetization back to equilibrium state. For Li₃PS₄, a T₁ of 2.1 ms was measured, in comparison to 0.9 ms for Li₃P3.69O_{0.31}. Showing that the T₁ was more than halved upon oxygen substitution, which was indicative of increased Li-ion mobility upon oxygen substitution, which was also reflected in the EIS data.

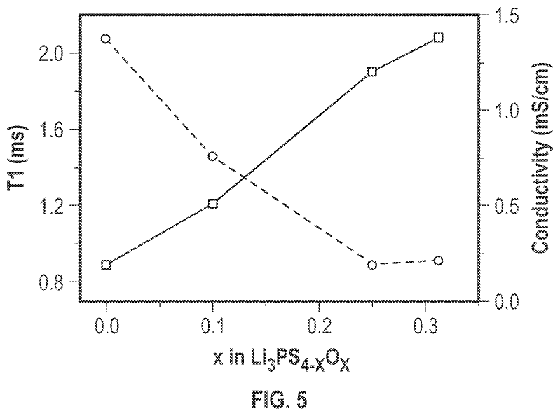

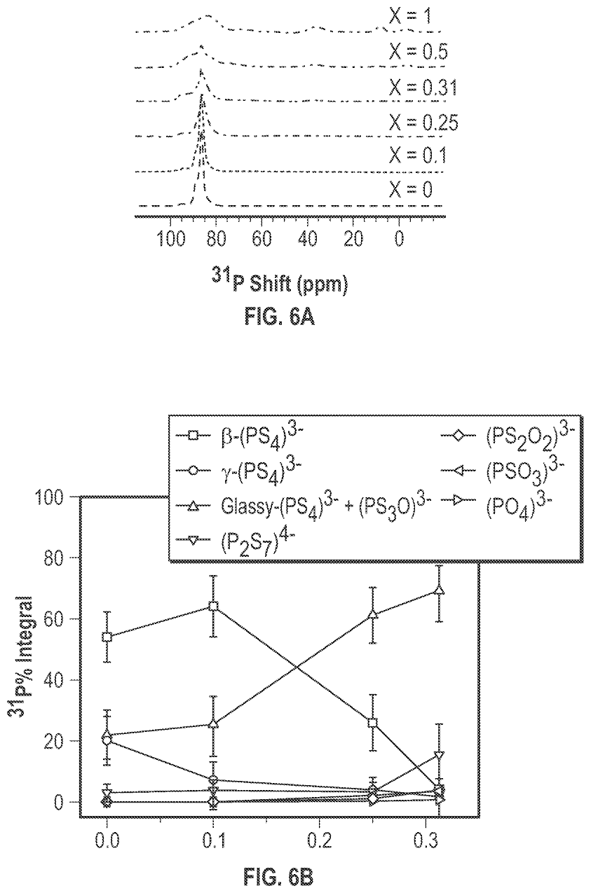

The local environment of the anionic sublattice in Li₃PS₄₋ₓOₓ was investigated with ³¹P NMR and the results are shown at FIG. 6A. FIG. 6A depicts ³¹P MAS NMR spectra for x in Li₃PS₄₋ₓOₓ. Assigned deconvoluted peaks for Li₃PS₄, Li₃PS_{3.9}O_{0.1}, Li₃PS_{3.75}O_{0.25}, and Li₃P3.69O_{0.31} are shown in FIG. 4B with the corresponding quantitative results shown at FIG. 6B. FIG. 6B depicts ³¹P quantitative analysis for Li₃PS₄₋ₓOₓ, (x=0, 0.1, 0.25, and 0.31. The most intense resonance at 86.3 ppm was assigned to the crystalline (PS₄)³ unit, in which the peak intensity decreased and gradually evolved into a featureless lineshape as the amount of oxygen substitution increased (FIG. 6A). This correlated well with the observed trend from the PXRD patterns (FIG. 1A) such that the incorporation of O into β-Li₃PS₄ created more disordered environments, i.e., loss of crystallinity, as manifested by the wide distribution of ³¹P resonance at 86.3 ppm.

The ³¹P resonances at 88 ppm and at 93 ppm were assigned to the (γ-PS₄)³⁻ unit and the (P₂S₇)^{4 -} unit, respectively. Li₃P3.69O_{0.31} showed a minimum ³¹P integral % of the (γ-PS₄) 3 unit and a maximum for that of the (P₂S₇)⁴ unit. In addition, an unknown sulfide impurity peak became apparent at 91 ppm, beginning when x=0.5. Since the unknown appeared small by intensity and likely did not contribute much to the changes in conductivity, it was not further studied. Upon greater oxygen introduction, lithium phosphate impurity peaked at 75 ppm, 70 ppm, 37 ppm, 9 ppm, and-3 ppm were increasingly formed, which were assigned to (POS₂)⁻(PS₂O₂)³⁻, (PSO₃)³⁻, (PO₄)³⁻ and (P₂O₇)⁴⁻, respectively, as seen in FIG. 6A. The impurity lithium phosphates, particularly Li₃PO₄, were considered to have low ionic conductivity and likely contributed to the decrease in ionic conductivity when x>0.31. These results were also supported by the enthalpy of mixing calculations from FIG. 1B, as they suggested the metastability of x=0.5 and 1 and the thermodynamically favorable formation of stable decomposition products such as the low conducting phosphates. Furthermore, a growing peak at 85 ppm upon oxygen substitution was assigned to a combined environment of glassy-(PS₄)³⁻ and (PS₃O)³⁻ units, as their individual shifts were very close to each other, making accurate deconvolution challenging. DFT NMR calculations for Li₃PS₄, Li₃PS_{3.875}O_{0.125}, and Li₃PS_{3.75}O_{0.25} confirmed the generation of a new peak for the (PS₃O)³⁻ unit and was also in close agreement with the experimental spectra (F).

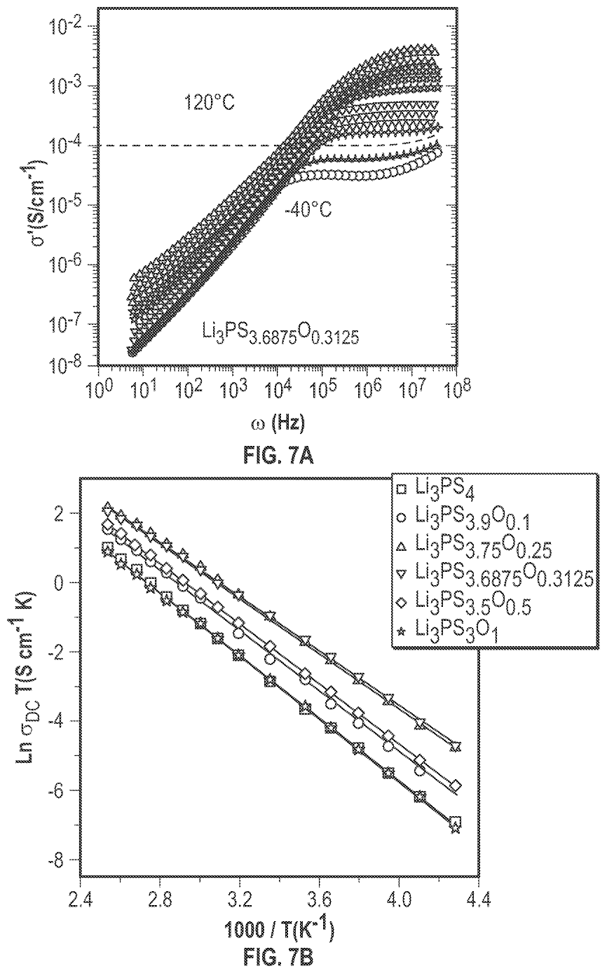

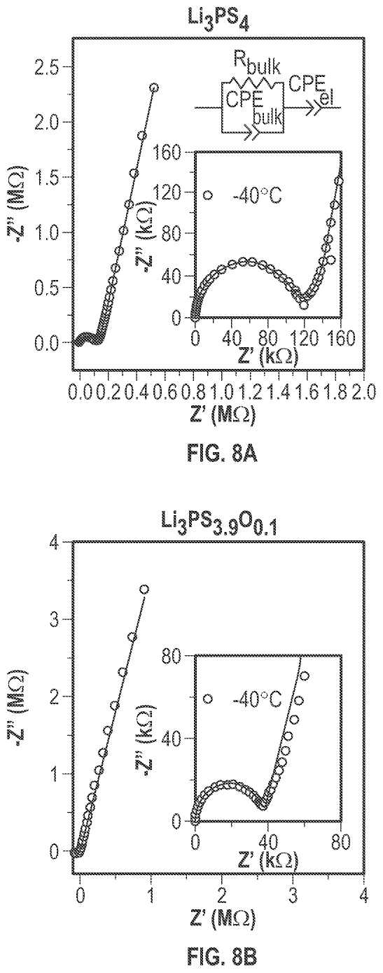

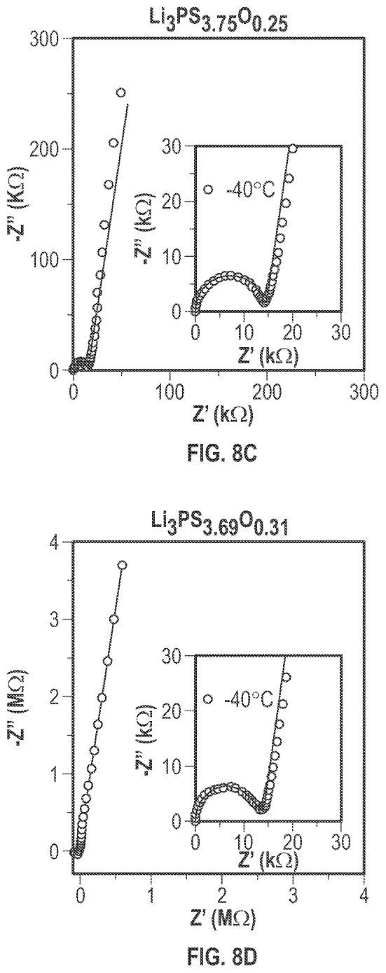

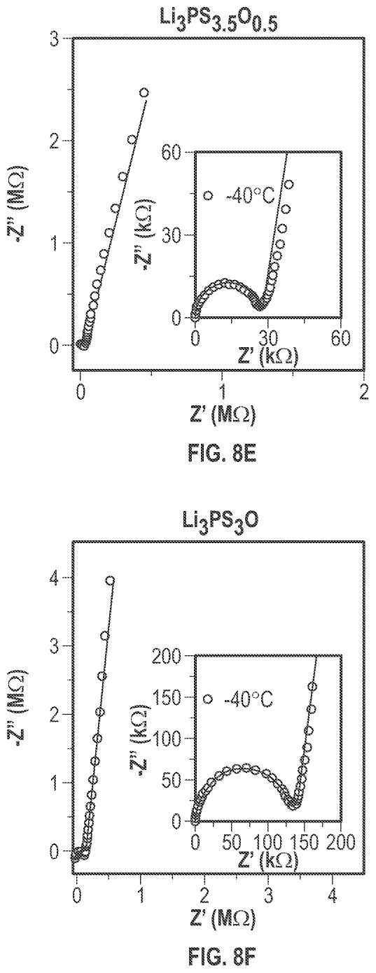

To relate the structure of Li₃PS₄₋ₓOₓ to the electrochemical performance, EIS was performed. The conductivity isotherms of Li₃PS_{3.69}O_{0.31} are shown at FIG. 7A. FIG. 7A depicts conductivity isotherms from −40° C. to 120° C., using Li₃PS_{3.69}O_{0.31} as an example. The filled symbol represents the isotherm measured at 25° C. The fitted line is extrapolated to y-axis for identification of ODC. From low (−40° C.) to high (120° C.) temperature, only one frequency-independent direct current (DC) plateau was observed. This suggested that the macroscopic Li-ion conduction involved bulk process. Examining the Nyquist plots for x in Li₃PS₄₋ₓOₓ at −40° C. (FIG. 8A-FIG. 8F) further supported this point as only one semicircle was detected, representing the bulk ionic conductivity. Towards higher temperatures, the DC plateau fell off the detection limit with the emergence of inductance causing the reverse reading of σ′. In addition, electrode polarization was shown at the lower frequency. FIG. 8A-FIG. 8F depict Nyquist plots of Li₃PS₄₋ₓOₓ at −40° C. Simulation of each plot was performed with an equivalent circuit shown in FIG. 3A, in which R and CPE stand for resistor and constant phase element respectively; el stands for blocking electrodes processes.

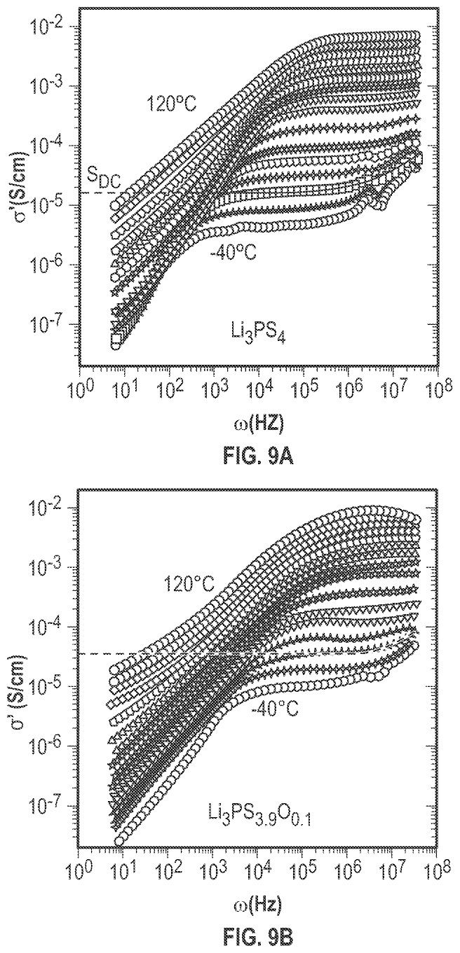

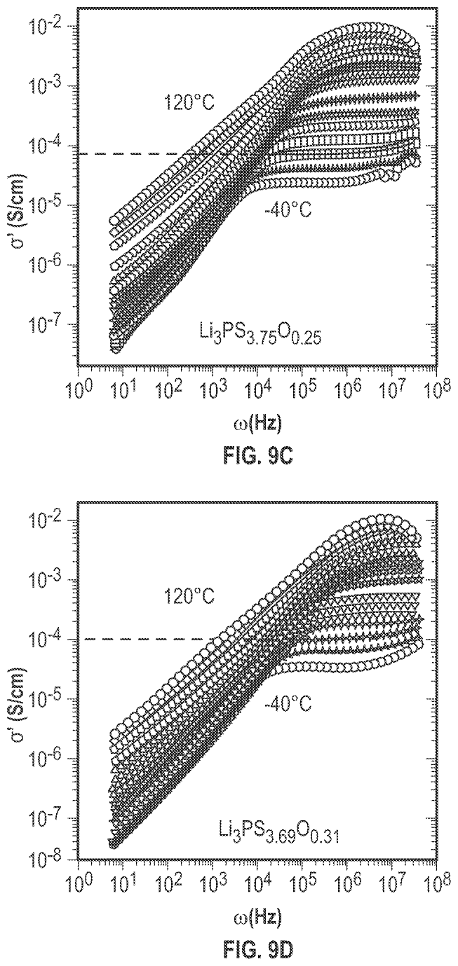

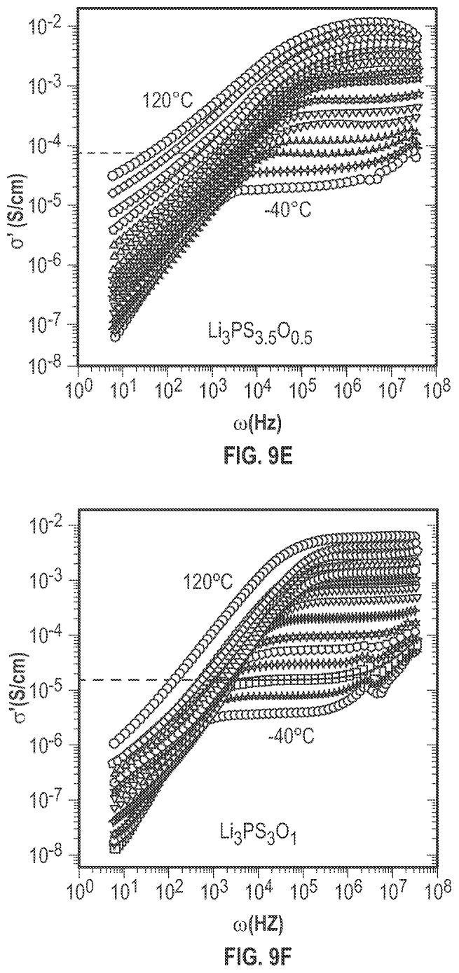

For the conductivity isotherms of Li₃PS₄₋ₓOₓ (x=0, 0.1, 0.25, 0.31, 0.5, and 1; FIG. 9A-FIG. 9F), the dependence of the real part (σ′) of the complex ionic conductivity on angular frequency (ω=2πf; f=scanning frequency), can be approximated with the Jonscher-type power law, σ′=σ_{DC}+Aωⁿ, where σ_{DC} is the DC conductivity, A is the alternating current coefficient, and n is the power law exponent.

FIG. 9A-FIG. 9F depict conductivity isotherms (σ′) of Li₃PS₄₋ₓOₓ acquired from −40° C. to 120° C. (increment of 10° C.; except 25° C.). ω(Hz)=2×π×f, f=scanning frequency (5 MHz to 1 Hz). DC ionic conductivity (σ_{DC}) is approximated with the Jonscher-type power law (σ′=σ_{DC}+Aωⁿ). A representative fitting curve at −20° C. is shown in each panel to demonstrate the change in σ_{DC} (cf. FIG. 5). Green filled symbols are designated to signals obtained at 25° C.

The obtained σ_{DC} of Li₃PS_{3.69}O_{0.31} reached a maximum of 1.38 mS/cm, giving greater than a sevenfold enhancement in ionic conductivity compared to the experimental Li₃PS₄, which had a opc of 0.19 mS/cm. Substituting O for S with x>0.31 in Li₃PS₄₋ₓOₓ lead to a reduction of ionic conductivity (see table below). The energy barrier of σ_{DC} could be quantified with E_{a,DC} using the Arrhenius law, σ_{DC}σ₀ exp (−E_{a,DC}/(k_{B}T)), where T is temperature in kelvin, σ₀ is the Arrhenius pre-factor, and k_{B} is the Boltzmann constant. As illustrated at FIG. 7B, a minimum E_{a,DC} of 0.34 eV was reached for Li₃PS_{3.69}O_{0.31}, indicating that the optimal amount of oxygen substitution lowered the energy barrier for macroscopic Li-ion conduction (sec table below). FIG. 7B depicts an Arrhenium plot for x in Li₃PS₄₋ₓO₂ sing the Arrhenius relation between opc and inverse temperature to calculate E_{a,DC}.

To better understand the EIS results, AIMD simulations were carried out at 600-1300 K for Li₃PS₄₋ₓOₓ: x=0.0, 0.125, 0.25, and 1.0. With O²⁻ doping, Li⁺ conductivity increased substantially. Optimal Oxygen concentration (x=0.25) lead to the highest conductivity and least Li-migration barrier (Eₐ). Gradual oxygenation and resulting faster diffusion behavior till x=0.25 were associated with widening of Li-diffusion channel. At higher oxygen concentration, say x=1, channel width dropped and so did the conductivity.

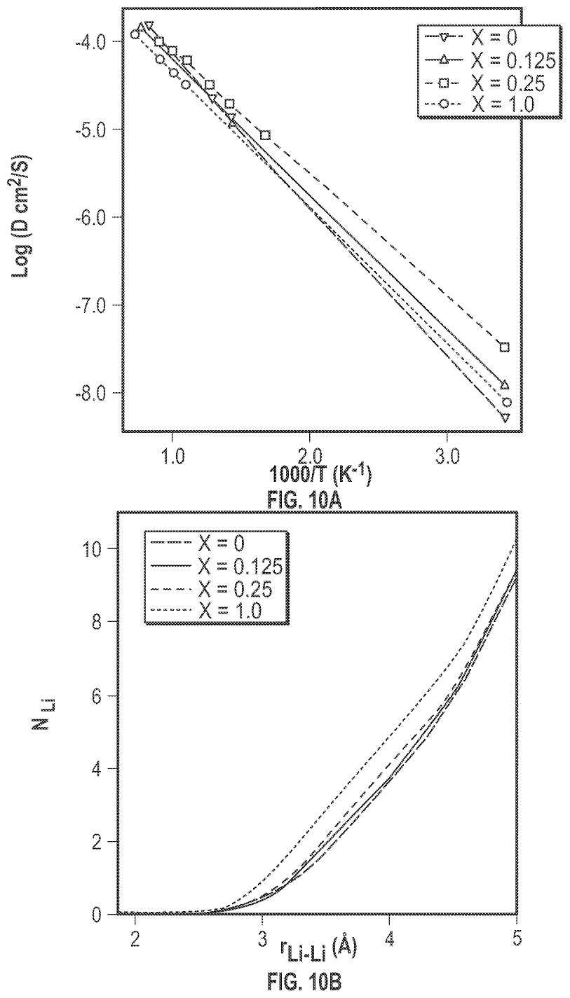

Although computational prediction of optimal value of x to maximize the Li-conductivity had close agreement with the experiment, it was noted that AIMD results depicted the diffusion behavior at high temperature (>600K), shown at FIG. 10A. FIG. 10A depicts Arrhenius plots for x in Li₃PS₄₋ₓOₓ. Indeed, a quantitative agreement between high temperature experimental behavior and AIMD derived Ea values were observed and discussed in the later section. Furthermore, the extrapolated room temperature conductivity was overestimated and Ea was underestimated. Nevertheless, optimal oxygenation lead to a decrease in the activation barrier, which was associated with redistribution of Li, as shown in the Li-Li correlation function (FIG. 10B). FIG. 10B depicts the number of Li with varying Li-Li distance, obtained from the AIMD-averaged Li-density at 600 K for 200 ps. Such Li-redistribution upon oxygenation lead to 2D to 3D transformation of the Li-conducting channels, according to lithium probability density results collected for Li₃PS₄, Li₃PS_{3.875}O_{0.125}, Li₃PS_{3.75}O_{0.25}, and Li₃PS₃O from ab initio molecular dynamics simulation (see table below).

Li probability density was plotted for three compositions of x in Li₃PS₄₋ₓOₓ, and the results showed that when near the optimal amount of oxygen substitution with respect to ionic conductivity, a change from quasi-2D to 3D Li-diffusion paths was observed. Also, at the upper limits of oxygen substitution, Li₃PS₃O, localized Li-hopping occurred with interrupted long-range diffusion. This coincided well with the experimental power law exponent measurements as discussed above.

This explained the enhanced three-dimensional diffusion at x=0.25. However, loss of interconnection among the Li-domains lead to lowering in the long-range ionic conductivity for higher x, Li₃PS₃O, despite the higher dimensionality.

Calculated activation energy, conductivtiy, and Li
channel width for Li₃PS₄, Li₃PS_{3.875}O_{0.125},
Li₃PS_{3.75}O_{0.25}, and Li₃PS₃O from ab initio
molecular dynamics simulations

| x | Eₐ, eV | σ, mS/cm | l, Å |
|---|---|---|---|
| 0 (β) | 0.33 ± 0.02 | 0.60-1.16 | 1.82 |
| 0.125 | 0.31 ± 0.02 | 1.32-2.51 | 1.83 |
| 0.25 | 0.28 ± 0.01 | 4.76-6.76 | 1.84 |
| 1 | 0.31 ± 0.02 | 1.05-1.81 | 1.71 |

The power law exponent, n, is an empirical indicator to describe the effective dimensionality for conducting solids. 3D conduction was typically correlated with n≥0.7. Through analyzing the conductivity isotherm (−20° C.) for Li₃PS₄₋ₓOₓ (FIG. 9A-FIG. 9F and the following table), a positive correlation between the exponent n and the amount of O²⁻ was observed.

Summary of EIS analysis on Li₃PS₄₋ₓOₓ (x = 0, 0.1, 0.25, 0.31, 0.5, and 1).

| | | σ_{DC} @ | | | | | |
|---|---|---|---|---|---|---|---|
| | E_{a, DC} | 25° C. | Ln σ₀ | | E_{a, M′′} | E_{ρ′, LT} | E_{ρ′, HT} |
| Sample | (eV) | (mS/cm) | (S/cm * K) | n | (eV) | (eV) | (eV) |
| Li₃PS₄ | 0.39 | 0.19 | 12.50 | 0.62 | 0.34 | 0.20 | 0.34 |
| Li₃PS_{3.9}O_{0.1} | 0.38 | 0.51 | 12.69 | 0.65 | 0.35 | 0.19 | 0.33 |
| Li₃PS_{3.75}O_{0.25} | 0.35 | 1.20 | 12.45 | 0.85 | 0.35 | 0.17 | 0.30 |
| Li₃PS_{3.69}O_{0.31} | 0.34 | 1.38 | 12.09 | 0.87 | 0.34 | 0.18 | 0.28 |
| Li₃PS_{3.5}O_{0.5} | 0.37 | 0.76 | 12.66 | 0.88 | 0.38 | 0.19 | 0.31 |
| Li₃PS₃O₁ | 0.39 | 0.20 | 12.55 | 0.95 | 0.39 | 0.23 | 0.33 |

E_{a, $} denotes activation energies obtained via EIS analysis under various conditions, in which $ = DC (direct current), M′′ (imaginary part of the complex electric modulus), and ρ′ (real part of resistivity), σ₀ is Arrhenius pre-exponential factor. n is the Jonscher-type power law exponent. LT and HT denote low-temperature and high temperature, respectively.

This suggested a change in dimensionality of Li-ion conduction from 2D (Li₃PS₄; n=0.62) to 3D (Li₃PS_{3.69}O_{0.31}; n=0.87). The improved dimensionality of conducting space was attributed to greater correlated ion motion.

This explained the lowering in ionic conductivity for Li₃PS_{3.5}O_{0.5} and Li₃PS₃O despite higher n. In fact, the exponent n represented the ratio of the backward hopping rate of ion motion to the site relaxation rate. Therefore, assuming the site relaxation rate was nearly the same, the stronger correlation among Li⁺—Li⁺ and the Li⁺—O²⁻ pairs may have caused a rise in the backward hopping rate, that is, an unsuccessful hopping for Li⁺ to jump through the potential minima.

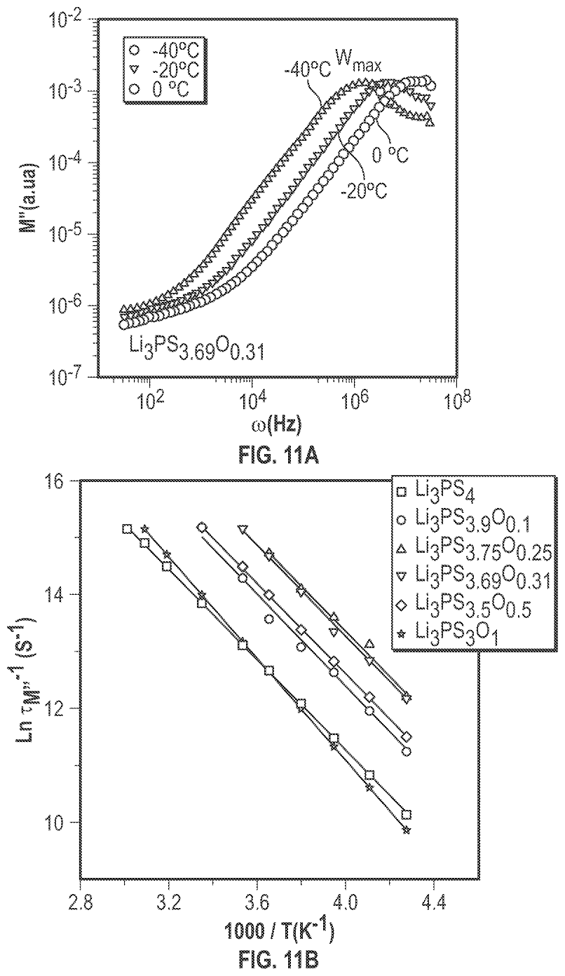

The physical picture of this behavior was localized ion hopping without any macroscopic Li-ion conduction. Also examined was whether the observed response of ion dynamics to frequency was coupled with grain boundary, i.e., low frequency response. Thus, the EIS data was analyzed with imaginary component of the complex electric modulus, M″. Take Li₃PS_{3.69}O_{0.31} as an example (FIG. 11A), M″ was computed from Z′ (the real part of the complex impedance) via ω·A·ε₀·Z′/l, in which A, ε₀, and l refer to the contact area between the indium electrode and Li₃PS₄₋ₓOₓ, the permittivity of free space, and the thickness of the Li₃PS₄₋ₓOₓ pellet, respectively. FIG. 11A depicts the frequency dependence of M″ (the imaginary part of the complex electric modulus) of Li₃PS_{3.69}O_{0.31}. ω(Hz)=2×π×f, f=scanning frequency from 5 MHz to 1 Hz. Only representative M″-isotherms are shown at FIG. 11A for the sake of clarity. Discontinuity of data points at high frequency were attributed to contact between the indium blocking electrodes and solid electrolyte.

The single peak confirmed that bulk process was likely exclusively responsible for the observed Li-ion conduction; otherwise, another shoulder associated with the grain boundary should have emerged at the lower scanning frequency. The broad and slightly asymmetric lineshape indicated that the bulk process involved a distribution of macroscopic diffusion in different pathways. The ωₘₐₓ was identified on each isotherm to calculate the electrical relaxation rate, τ_{M″}⁻¹(ωₘₐₓ/2π=fₘₐₓ=τ_{M″}⁻¹). As the temperature increased, the ωₘₐₓ shifts to higher frequency; therefore, faster relaxation. Then, the activation energy E_{a,M″} (FIG. 11B) was compared with E_{a,DC}. FIG. 11B depicts the temperature dependence of τ_{M″}⁻¹ of Li₃PS₄₋ₓOₓ (x=0,0.1,0.25,0.31, 0.5, and 1. A fair agreement between E_{a,M″} and E_{a,DC} suggested that the carrier concentration, i.e., Li⁺, throughout Li₃PS₄₋ₓOₓ (x=0, 0.1, 0.25, 0.31, 0.5, and 1) was almost the same.

The pre-factor could be understood according to the following equation:

$${σ}_{0} = z \frac{{N ( q )}^{2}}{{k}_{b}} {e}^{\frac{Δ {S}_{m}}{{k}_{B}}} {a}^{2} {v}_{0} \qquad ( 4 )$$

Where z was the geometric factor, k_{B} was the Boltzmann constant, N was the number of charge carriers, q was the charge of the ions, ΔSₘ was the migration entropy, α was the jump distance between sites, and ν₀ was the jump frequency. The number of charge carriers was not expected to largely contribute to the change in σ₀, because the amount of Li per formula remained constant for all the compositions. To determine the contribution of the jump frequency to the pre-factor, the crossover frequency, ω_{c}, was calculated according to:

$${ω}_{c} = {( \frac{{σ}_{D C}}{{σ}_{0}} )}^{\frac{1}{n}} \qquad ( 5 )$$

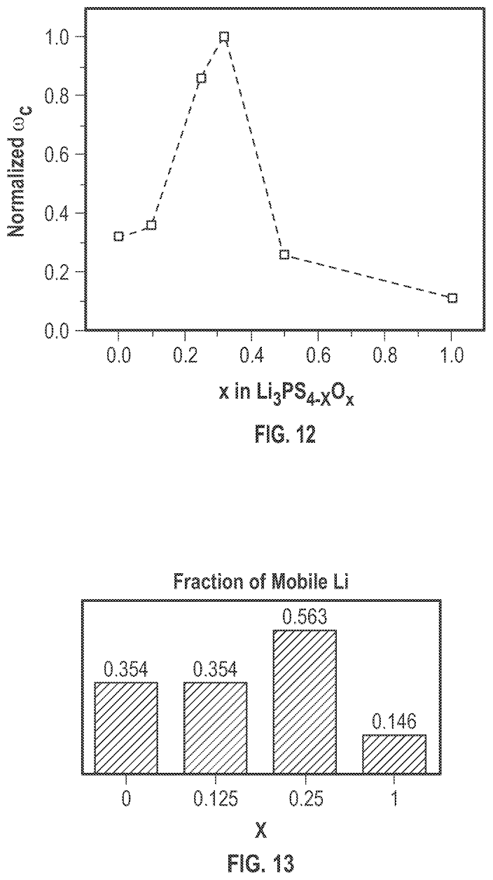

The crossover frequency, where the transition from the σ_{DC} plateau to the high-frequency dispersive region occurred, was used as an rough approximation for ν₀. The results given in FIG. 12 showed a change in ω_{c} within an order of magnitude and the trend opposite to the one observed for the σ₀, giving a maximum jump frequency for Li₃PS_{3.69}O_{0.31}. FIG. 12 depicts the normalized crossover frequency, ω_{c}, of Li₃PS₄₋ₓOₓ (x=0, 0.1, 0.25, 0.31, 0.5, and 1). ω_{c} is extracted from Equation 4 shown in main text. Dash line is a guide-to-eye.

Crossover frequency and normalized
values for x in Li₃PS₄₋ₓOₓ (x = 0, 0.1,
0.25, 0.31, 0.5, and 1).

| | | Normalized |
|---|---|---|
| Sample | ω_{c} (Hz) | ω_{c} |
| Li₃PS₄ | 2.08 × 10⁷ | 0.32 |
| Li₃PS_{3.9}O_{0.1} | 2.33 × 10⁷ | 0.36 |
| Li₃PS_{3.75}O_{0.25} | 5.53 × 10⁷ | 0.86 |
| Li₃PS_{3.69}O_{0.31} | 6.44 × 10⁷ | 1.00 |
| Li₃PS_{3.5}O_{0.5} | 1.69 × 10⁷ | 0.26 |
| Li₃PS₃O₁ | 7.11 × 10⁶ | 0.11 |

From this, the change in jump frequency was not expected to contribute largely to the change in oo either, otherwise the trend would have followed that of the Arrhenius prefactor. Moreover, the migration entropy (ΔSₘ), as illustrated in the Meyer-Neldel rule, was increased because more activated sites became available for Li⁺ to visit (FIG. 13). FIG. 13 depicts fractions of Li exhibiting MSC >5 Å² from the 600K AIMD trajectory of 200 ps with respect to x in Li₃PS₄₋ₓOₓ. However, it should be noted that for macroscopic Li-ion conduction to occur other factors such as dimensionality, successful ion hopping, were considered. Considering the pattern of crossover frequency (ω_{c}) (FIG. 12) and entropy of migration (ΔSₘ), and their minimal role in affecting σ₀, other factors including correlation factors likely had a large impact on determining the Arrhenius prefactor.

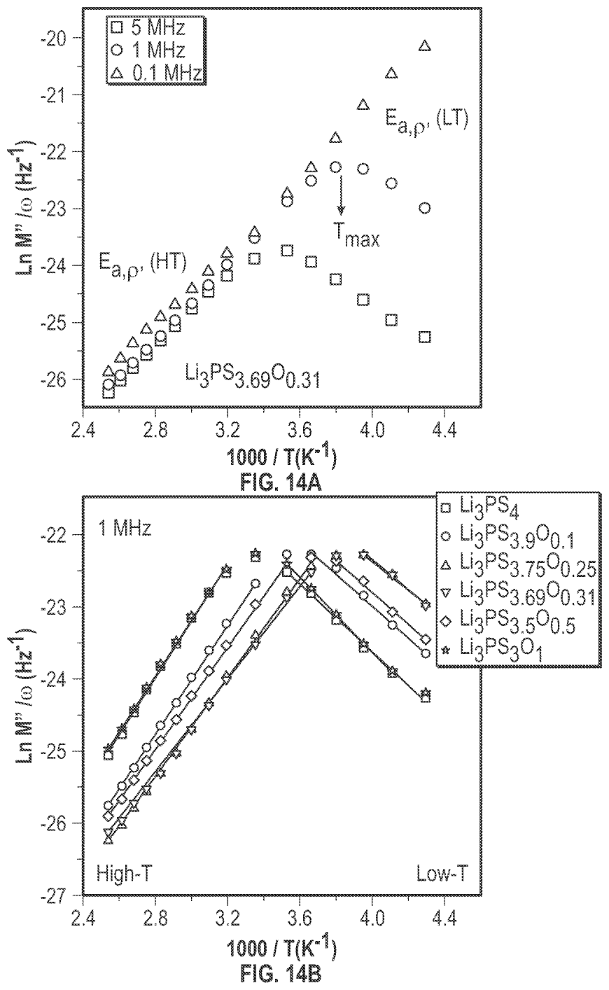

To study ion dynamics on a different time-scale, the real part of resistivity (ρ′=M′/ω) as a function of temperature was examined. As seen at FIG. 14A, faster ion dynamics lead to the shift of the ρ′-peak toward the low-T side. FIG. 14A depicts the real part of resistivity (ρ′) of Li₃PS_{3.69}O_{0.31} as a function of inverse temperature. Three representative peaks are shown with respect to the scanning frequency at 5, 1 and 0.1 MHz, respectively. Each ρ′-peak presented high-temperature (HT) and low-temperature (LT) flank, which characterized the activation energy for long-range (E_{a,σ′(HT)}) and short-range (E_{a,σ′(LT)}) ion motion, respectively.

This feature resembled the NMR T₁ relaxation rate, which permitted the ion dynamics on different length scale, i.c., short-range vs. long-range, to be probed. To characterize ion dynamics on both scales with activation energy, ρ′-peaks (1 MHZ) of all Li₃PS₄₋ₓOₓ (x=0, 0.1, 0.25, 0.31, 0.5, and 1) were collectively compared. As displayed at FIG. 14B, T_{max,ρ′} characterizes the temperature at which the maximum quantity of ρ′ appears. The faster the ion motion is, the lower the T_{max,ρ′} was detected. FIG. 14B depicts the temperature dependence of ρ′of Li₃PS₄₋ₓOₓ (x=0, 0.1, 0.25, 0.31, 0.5, and 1) when measured at 1 MHz. Accordingly, Li₃PS_{3.69}O_{0.31} shows the lowest T_{max,ρ′}. Following the Arrhenius law, the high temperature activation energy (E_{a,σ′(HT)}) and low temperature activation energy (E_{a,σ′(LT)}) could be determined in Li₃PS₄₋ₓOₓ (FIG. 14B). Solid lines represent the Arrhenius fit for the high-T and low-T regime of ρ′-peaks. The least energy barrier of long-range conduction (E_{a,σ′(HT)}) for Li-ion conduction was identified with Li₃PS_{3.69}O_{0.31}. The trend of both the E_{a,σ′(HT)} and E_{a,σ′(LT)} was in line with that of σ₀, implying that the Arrhenius pre-factor played the key role in dictating the activation energy. Moreover, the E_{a,σ′(HT)} values were quite close to the simulated long-range diffusion energy barrier predicted via AIMD, giving further evidence to the reliability of both techniques to probe on a large length scale.

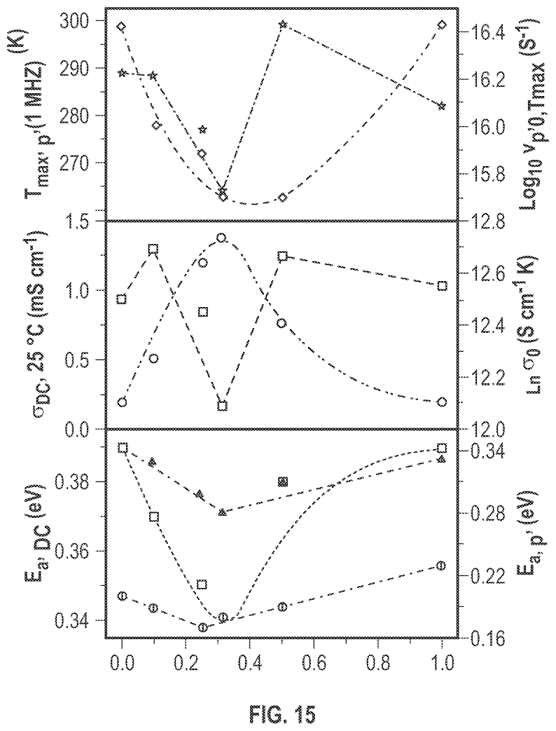

The overall evolution of Li-ion conduction in Li₃PS₄₋ₓOₓ (x=0, 0.1, 0.25, 0.31, 0.5, and 1) is summarized at FIG. 15 and several features can be drawn. FIG. 15 depicts VT-EIS summary for x in Li₃PS₄₋ₓOₓ; the dash lines are guide-to-eye.

The change in the characteristic temperature, T_{max,ρ′}, shared a similar pattern with the E_{a,DC} but related to σ_{DC} with an opposite fashion. All these physical parameters showed that Li₃PS_{3.69}O_{0.31} possessed the highest Li-ion conduction, which was in accordance with the Meyer-Neldel rule 2) Both the pre-factors (ν_{ρ′} and ρ0) experienced a similar dependence on temperature, in which the smallest value of the pre-factors was found as in the case of the activation energies (E_{a,DC} and E_{a,ρ′}). Consequently, the balanced factors in Li₃PS_{3.69}O_{0.31} lead to the optimal performance as revealed by EIS. 3) short-range and long-range experimentally determined energy barriers aligned well with that from simulations and showed that a low long-range energy barrier appeared to be important for obtaining high overall conductivity.

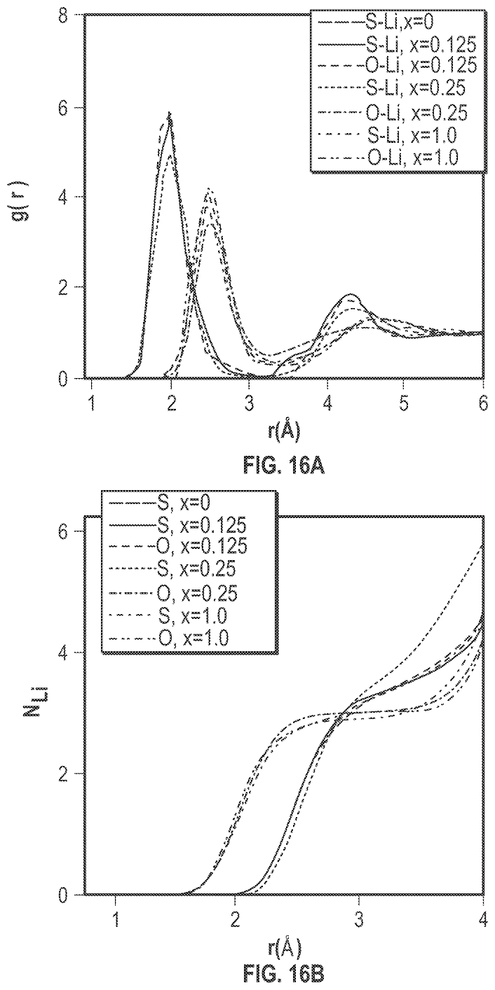

Also analyzed was the Li-A (A=O, S) bonding characteristics in order to investigate the origin of the tunable Li-diffusion path after oxygenation. FIG. 16A depicts radial pair distribution functions of S—Li and O—Li bond pairs for varying concentration of oxygen in Li₃PS₄₋ₓOₓ. Specifically, FIG. 16A depicts the radial pair distribution function of S—Li and O—Li bond pairs for varying concentrations of oxygen in Li₃PS₄₋ₓOₓ.

How the Li-ion number density surrounding S and O within the 1^{st} coordination sphere evolved are shown in at FIG. 16B. FIG. 16B depicts the number of Li (nLi) surrounding S and O within the first coordination shell; the results were derived from 600 K AIMD trajectory. There were three noteworthy findings: firstly, within the first coordination shell Li-ion concentration was higher in the vicinity of ‘S’ compared to ‘O’, leading to inhomogeneous Li-distribution throughout the framework. Despite the smaller sized O incorporation there was no significant volume shrinkage up to x=0.25. As a result, Li-density remained dispersed up to x=0.25, leading to the wide Li-diffusion channel and fast Li-conduction in the oxygenated framework. Li-density in the first coordination shell surrounding O/S was enhanced for x=1.0, pointing towards the localized Li due to overall decrease in free volume. Thus, further increase in the oxygen content lead to the narrow diffusion channel and slow Li-conduction.

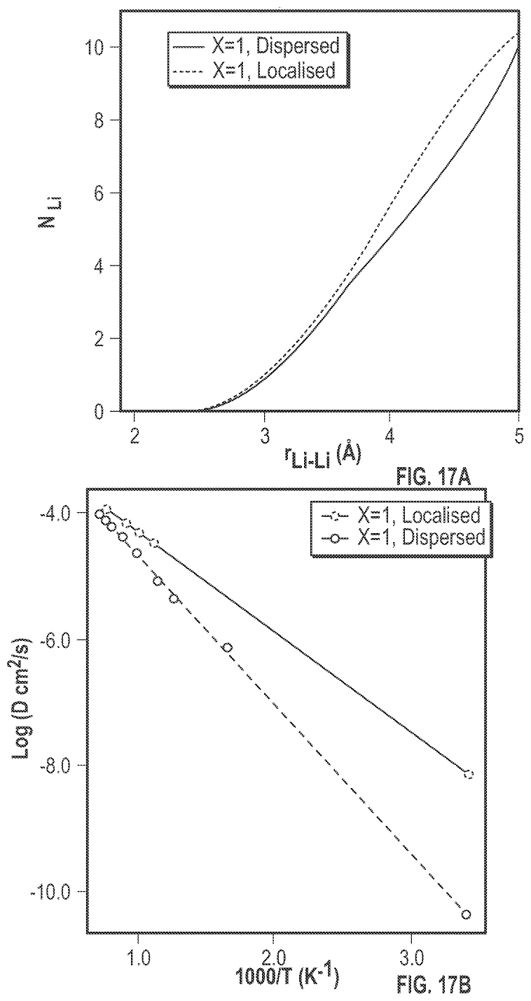

To isolate the effect of relative position of O-content for the chemical stoichiometry, x=1, two structural configurations of Li₃PS₃O: (i) Dispersed: PS₃O units (ii) Localized: both PS₄ and PS₂O₂ units were examined. Specifically, Li-distribution in Li₃PS₃O with two different O-distribution patterns: localized and dispersed O-atoms containing PS₂O₂ and PS₃O moiety, respectively, at a particular oxygen concentration, x=1. The Li chemical environment (FIG. 17A and the following table) for these two different structural analogues of the same composition Li₃PS₃O were significantly different. FIG. 17A depicts Li spatial density with respect to the Li-Li distance parameter. The results were obtained from 600 K AIMD trajectory for 200 ps.

Calculated NMR shift for Li₄₈P₁₆S₄₈O₁₆ (localized)
and Li₁₂P₄S₁₂O₄ (dispersed). The experimental
NMR results support that the dispersed structure
was synthesized.

| | | | | Relative |
|---|---|---|---|---|
| Composition | Ion | Span | Skew | Chemical Shift |
| Li₄₈P₁₆S₄₈O₁₆; x = 1 | Li | 6.91 | −0.45 | −0.34 |
| | Li | 7.85 | −0.05 | −0.08 |
| | Li | 6.77 | −0.25 | 1.48 |
| | Li | 7.85 | −0.05 | −0.08 |
| | P | 80.47 | 0.44 | 75.12 |
| Li₁₂P₄S₁₂O₄; x = 1 | Li | 5.99 | −0.06 | 0.32 |
| | Li | 7.39 | 0.18 | 1.79 |
| | Li | 7.69 | 0.56 | 0.83 |
| | Li | 3.33 | −0.04 | 1.01 |
| | P | 48.09 | 0.8 | 43.47 |
| | P | 116.64 | 0.66 | 86.27 |

Dispersed O-arrangement exhibited more downfield Li-chemical shift compared to the localized O-arrangement, associated with a much lower Li-migration barrier for the former, 0.31±0.02 meV versus 0.46±0.03 meV (FIG. 17B). This computational experiment highlighted the importance of the spatial arrangement of O-content to directly correlate with the degrees of Li-distribution, hence enhanced lithium conductivity. The spatial effect became more prominent at higher O-content, e.g., x=1. Thus, not only the composition, but also the O-distribution appears to have regulated the Li chemical environment and induced significant changes to flatten energy landscape to promote fast Li-diffusivity. The (PS₃O)₃₋ unit was expected for successful incorporation of oxygen into the β-Li₃PS₄ structure and was apparently important for the conductivity enhancement. With respect to ionic conductivity, the optimal amount of (PS₃O)₃₋, i.e., oxygen substitution, should be achieved without the generation of low conducting phosphate impurities containing (PSyO_{4-y})³⁻(y>1).

Thus, varying oxygen concentration tuned the Li-ion redistribution surrounding S and O, leading to maximum or increased widening of the Li-diffusion channel at a critical composition of Li₃PS_{3.75}O_{0.25}. Criticality arose because for sufficiently low oxygen concentration (0≤x≤0.25 in Li₃PS₄₋ₓOₓ) oxygenated thiophosphates motifs were well dispersed, which in combination with inhomogeneous Li-distribution surrounding S and O resulted in a gradual increase in the free volume. However, further increase in the O-content resulted in close proximity of the O-domains and overall shrinkage of the lattice (hence channel width) due to shorter Li—O bonds which attributed to sluggish Li-diffusion.

We claim:

1. A method of forming an electrolyte, the method comprising:
contacting Li₂S, P₂S₅, and P₂O₅ to form the electrolyte.

2. The method of claim 1, wherien the electrolyte comprises a material of formula (I):
Li₃PS₄₋ₓOₓ formula (I);
wherein 0<x≤1.

3. The method of claim 1, wherein the contacting of Li₂S, P₂S₅, and P₂O₅ comprises mixing Li₂S, P₂S₅, and P₂O₅, and (ii) homogenizing Li₂S, P₂S₅, and P₂O₅ under vacuum.

4. The method of claim 1, wherein the contacting of Li₂S, P₂S₅, and P₂O₅ comprises mixing Li₂S, P₂S₅, and P₂O₅.

5. The method of claim 1, wherein the contacting of Li₂S, P₂S₅, and P₂O₅ comprises homogenizing Li₂S, P₂S₅, and P₂O₅ under vacuum.

6. The method of claim 5, wherein the homogenizing of Li₂S, P₂S₅, and P₂O₅ under vacuum comprises milling Li₂S, P₂S₅, and P₂O₅ with a milling media, wherein a weight ratio of the milling media to the total weight of Li₂S, P₂S₅, and P₂O₅ is about 10:1 to about 20:1.

7. The method of claim 6, wherein the weight ratio of the milling media to the total weight of Li₂S, P₂S₅, and P₂O₅ is about 12:1 to about 16:1.

8. The method of claim 6, wherein the weight ratio of the milling media to the total weight of Li₂S, P₂S₅, and P₂O₅ is about 14:1.

9. The method of claim 1, wherein the electrolyte is a powder.

10. The method of claim 1, wherein the electrolye is a powder, and the method further comprises pressing the powder into a pellet.

11. The method of claim 10, wherein the pressing of the powder into the pellet comprises subjecting the powder to a pressure of at least 200 MPa, and a temperature of at least 200° C.

12. The method of claim 11, wherein the powder is subjected to the pressure and the temperature simultaneously.

13. The method of claim 11, wherein the powder is subjected to the pressure and the temperature sequentially.

14. A method for forming an electrolyte, the method comprising:
contacting Li₂S, P₂S₅, and P₂O₅ to form the electrolyte;
wherien the electrolyte comprises a material of formula (I)-
Li₃PS₄₋ₓOₓ formula (I);
wherein 0<x≤1;
wherein the contacting of Li₂S, P₂S₅, and P₂O₅ comprises mixing Li₂S, P₂S₅, and P₂O₅, and (ii) homogenizing Li₂S, P₂S₅, and P₂O₅ under vacuum.

15. The method of claim 14, wherein the electrolye is a powder, and the method further comprises pressing the powder into a pellet.
